(19) United States
(12) Patent Application Publication
(10) Pub. No.: US 2020/0089679 A1
(43) Pub. Date: Mar. 19, 2020

(54) ANNOTATED QUERY GENERATOR

(71) Applicant: ENTIT SOFTWARE LLC, Sunnyvale, CA (US)

(72) Inventors: Alper Okcan, Cambridge, MA (US); Thao Nguyen PHAM, Cambridge, MA (US); Nga TRAN, Cambridge, MA (US); Chuck Edward BEAR, Cambridge, MA (US)

(21) Appl. No.: 15/750,654

(22) PCT Filed: Aug. 7, 2015
(86) PCT No.: PCT/US2015/044193

§ 371 Date: Feb. 6, 2018

(51) Int. Cl. G06F 16/2453; G06F 16/22

(52) U.S. Cl. CPC G06F 16/24544; G06F 16/2255

(57) ABSTRACT

Examples herein involve providing a first query to an optimizer; identifying a first execution plan selected by the optimizer based on the first query; generating an annotated query based on the selected first execution plan, the annotated query comprising hints for executing the selected first execution plan; and storing the annotated query in a database, the annotated query to cause the optimizer to generate a second execution plan corresponding to the first execution plan based on the hints.

### BACKGROUND

Data management systems maintain data storages. Users may interact with the data management system to access data in the data storages by providing queries to the data management systems. For example, a user may submit queries to the data management system requesting that corresponding data be retrieved and/or presented (e.g., via reports).

### BRIEF DESCRIPTION OF THE DRAWINGS

FIG. 1 is a schematic diagram of an example database management system including a query manager implemented in accordance with an aspect of this disclosure.

FIG. 2 is a block diagram of an example query manager that may be used to implement the query manager of FIG. 1.

FIG. 3 is a flowchart representative of example machine readable instructions that may be executed to implement the query manager of FIG. 2.

FIG. 4 is another flowchart representative of example machine readable instructions that may be executed to implement the query manager of FIG. 2.

FIG. 5 is yet another flowchart representative of example machine readable instructions that may be executed to implement the query manager of FIG. 2.

FIG. 6 is a block diagram of an example processor platform capable of executing the instructions of FIGS. 3, 4, and/or 5 to implement the query manager of FIG. 2.

Wherever possible, the same reference numbers will be used throughout the drawing(s) and accompanying written description to refer to the same or like parts.

### DETAILED DESCRIPTION

Examples disclosed herein involve directed queries that cause an optimizer to select an execution plan for a query using hints, in examples herein, a query manager generates annotated queries from execution plans selected by an optimizer of a database management system. The annotated queries may include hints to cause the optimizer to select an execution plan corresponding to the hints. In some examples, customized annotated queries may be provided to the query manager via user input to cause the optimizer to generate an execution plan in accordance with hints of the customized annotated queries.

Due to the frequently changing state of a database (e.g., updates, added data, removed data, copied data, etc.), an optimizer of a database management system may adjust execution plans for queries to account for the changing states. In some instances, this may affect speed of processing a query (e.g., retrieval of data may be slower than a previously selected execution plan). Examples herein generate annotated queries to store respective execution plans for corresponding queries. An example query manager may provide the annotated queries to an optimizer instead of a corresponding query to enhance execution timing of the query by reverting back to a previously selected execution plan. This annotated query may be provided because a new execution plan that processes the query is slower than the previously selected execution plan. Thus, by providing the annotated query to the optimizer, the optimizer may revert back to the previously selected execution plan rather than continue to use the slower new execution plan. In examples herein, a query manager may map queries (e.g., using a hash and an index) to corresponding annotated queries such that when a same query is subsequently received, the query manager provides the optimizer with the annotated query (rather than the query),

As used herein, a query is a request for information/data from a database. In examples herein, an optimizer selects execution plans for queries submitted to a database management system. Example optimizers herein may be implemented using any suitable means. It is noted that, in examples herein, an optimizer may or may not select an “optimal” execution plan for queries.

Examples herein involve providing a first query to an optimizer; identifying a first execution plan selected by the optimizer based on the first query; generating an annotated query based on the selected execution plan, the annotated query comprising hints for executing the selected execution plan; and storing the annotated query in a database, the annotated query to cause the optimizer to generate a second execution plan corresponding to the first execution plan based on the hints.

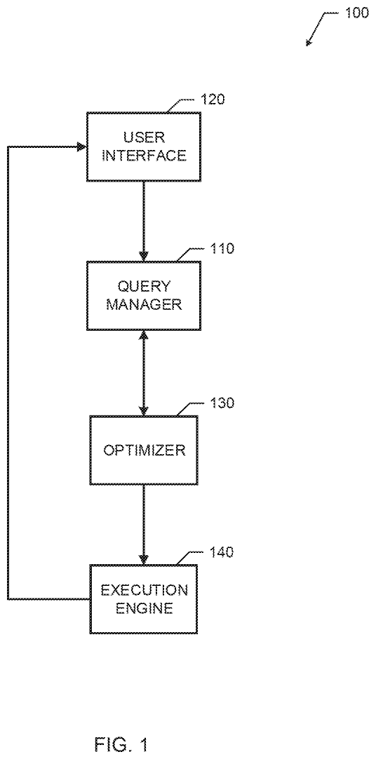

FIG. 1 is a schematic diagram of an example database management system 100 including a query manager 110 implemented in accordance with an aspect of this disclosure. The example database management system 100 includes the query manager 110, a user interface 120, an optimizer 130, and an execution engine 140. In the example database management system 100 of FIG. 1, the query manager 110 handles queries received via the user interface 120 and provides the queries or corresponding annotated queries to the optimizer 130, which selects an execution plan to be run by the execution engine 140 to process the query.

The example user interface 120 facilitates user interaction with database management system 100. For example, the user interface 120 may include input device(s) (e.g., a keyboard, a mouse, a trackball, a microphone, etc.) and output device(s) (e.g., a display, speaker(s), etc.). In examples herein, a user may input queries (e.g, structured query language (SQL) queries) for execution/processing by the execution engine 140. In some examples, a user may input user annotated queries via the user interface 120. For example, the user may provide a query and subsequently provide a user annotated query with instructions to match the query to the user annotated query. Accordingly, when the query is subsequently received from the user interface, the user annotated query is provided to the optimizer 130.

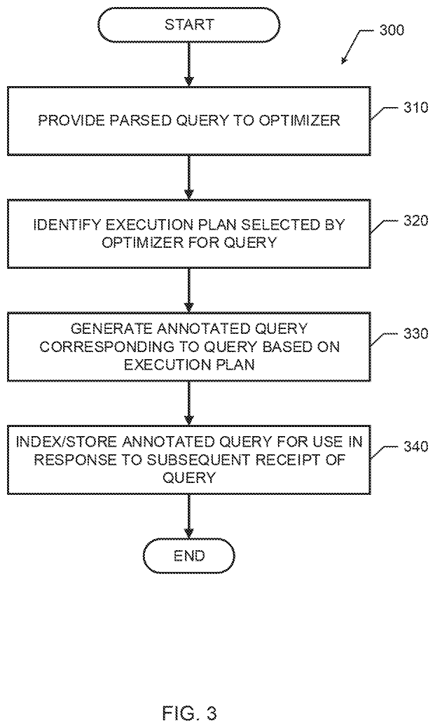

The example optimizer 130 of FIG. 3 selects an execution plan to process/execute the query. In examples herein, the optimizer 130 selects the execution plan based on any number of factors related to the data management system, for example, expected execution time, quality, etc. The optimizer 130 may weigh any suitable factors to select an appropriate execution plan for a particular query.

In examples herein, the optimizer 130 may receive an annotated query from the query manager. The annotated query may include hints (which may be referred to interchangeably herein as annotations) that instruct the optimizer 130 to select an execution plan according to the hints or cause an execution engine to execute an execution plan according to the hints. The annotated query may correspond to a previously received query or a query stored/managed by the query manager 110. The hints of the annotated query may constrain the optimizer 130 to select an execution plan from a single option (e.g., an execution plan that was previously executed for a query corresponding to the annotated query). Therefore, the optimizer 130 may select a different execution plan to retrieve the same data when the annotated query is received versus when the corresponding query was received. The optimizer 130 selecting the different execution plan for the annotated query may take less time to retrieve the data relative to the optimizer 130 selecting an execution plan for the corresponding query.

The example execution engine 140 executes the execution plan selected by the optimizer 130 to retrieve data requested in the corresponding query or annotated query. The execution engine 140 may then provide the retrieved data back to the user interface 120 for interaction with the user (e.g., display, editing, etc.).

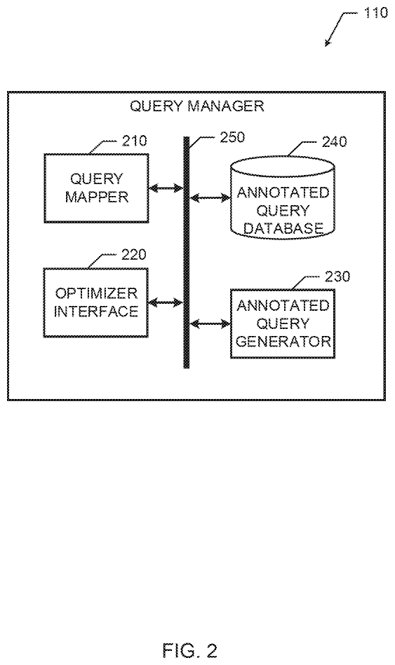

The example query manager 110 of FIG. 1 receives queries from the user interface 120 and provides the queries or annotated queries corresponding to the queries to the optimizer 130 in accordance with examples herein. The query manager 110 may provide annotated queries corresponding to received queries to the optimizer 130 to decrease execution time to process the query. In examples herein, the query manager 110 may determine whether a received query has been previously received (e.g., by checking an index of an annotated query database). If the query has not been previously received, the query manager 110 may forward the query onto the optimizer 130. In examples herein, if the same query has been received in the past (i.e., the present query matches the past query), the query manager 110 may provide a corresponding annotated query to the query optimizer 130. An example implementation of the query manager is discussed below in connection with FIG. 2.

FIG. 2 is a block diagram of an example query manager 110 that may be used to implement the query manager 110 of FIG. 1. The example query manager 110 of FIG. 2 includes a query mapper 210, an optimizer interface 220, an annotated query generator 230, and an annotated query database 240. A communication bus 250 facilitates communication between the query mapper 210, the optimizer interface 220, the annotated query generator 230, and the annotated query database 240. The query manager 110 of FIG. 2 manages queries received in the database management system 100 of FIG. 1 and provides the received queries or corresponding annotated queries to the optimizer 130 to select an execution plan for the received queries.

The example query mapper 210 of FIG. 2 maps queries the annotated query database 240 (e.g., using a hash and an index). In examples herein, the query mapper 210 may parse a received query (e.g., into a query parse tree) upon receipt. The query mapper 210 determines whether a matching query (e.g., a same query) was previously received using the annotated query database 240. The example query mapper 210 may check the annotated query database 240 to determine whether the same query has been mapped. In some examples, the query mapper 210 may calculate a hash of the received query (or a hash of the parsed query). In such examples, the query mapper 210 may check for a matching hash (e.g., an index hash) in the annotated query database 240 (or in an index of the annotated query database 240),

In examples herein, if the query mapper 210 determines that a received query has not been received in the past (i.e., there is no correspond entry in the annotated query database 240), the query mapper 210 may create an entry in the annotated query database 240. The new entry in the annotated query database 240 may maps the query (and/or a hash of the query) to an annotated query. Accordingly, when the received query is subsequently received, the query mapper 210 may refer to the entry in the annotated query database 240 to retrieve an annotated query. If the query mapper 210 determines that the received query has been received in the past (e.g., based on a hash of the query, comparison of the query and a query in the annotated query database 240), the query mapper 210 may retrieve a corresponding annotated query mapped to the received query from the annotated query database 240.

The example optimizer interface 220 facilitates communication with the optimizer 130 of the data management system 100. The example optimizer interface 220 may provide the received query and/or a corresponding annotated query to the optimizer 130 (based on whether the received query was previously received). In examples herein, the optimizer interface 220 may monitor or communicate with the optimizer 130 to identify/determine execution plans selected for queries. For example, if a query was provided to the optimizer 130 (rather than an annotated query), the optimizer interface 220 may monitor the optimizer 130 to identify the selected execution plan for the execution engine 140. The optimizer interface 220 provides the selected execution plan to the annotated query generator 230 to create an annotated query that corresponds to the query.

In examples herein, the annotated query generator 230 generates annotated queries from execution plans selected by the optimizer 130. The annotated query generator 230 may parse the execution plan to identify an order and process of the execution plan. Based on the order and process, the annotated query generator 230 creates an annotated query corresponding to the query along with hints. In examples herein, the hints may include join orders, distribution operation, join types, projection choices, etc. In some examples custom hints may be used to offer flexible execution plans. For example, for a query seeking data from a current month (e.g., “April”), a hint may be included to ignore the month (e.g., “March”) listed in the initial query, and use the current month (e.g., “April”) at the time of providing the annotated query. Accordingly, the hints may be included as annotations within the query itself and identify specific operations that are to be performed in executing the annotated query.

It is reiterated that the annotated query is to cause an optimizer to select an execution plan that returns the same data as an execution plan selected by the optimizer 130 when receiving the corresponding query. However, the execution plans themselves (e.g., order of operation, types of operations, etc.,) may be different from one another. The annotated query generator 230 stores the created annotated query in the entry created when the corresponding query was received.

For illustrative purposes,for the following example query:

SELECT c,name

FROM customer c, item i, purchase p

WHERE c.cid=p.cid AND p.iid=i.iid

AND i.type=‘household’

AND c.age<30

AND Month(p,date)=‘March’; (1)

the annotated query generator 230 create the following based on an execution plan selected by the optimizer 130:

SELECT/*syntactic_join*/c.name

FROM ((purchase p JOIN/*+Jtype(H)*/customer c
ON c.cid=p.cid)
JOIN/*+Jtype(H)*/item i, ON p.iid=i.iid)

WHERE i.type=‘household’

AND cage<30

AND Month(p,date)=‘March’; (2)

In the above examples, the annotated query (2) includes hints that cause an optimizer 130 to select an execution plan that effectively is a same execution plan that was previously selected by the optimizer 130 to process the query (1).

The example annotated query database 240 stores annotated queries in accordance with aspects of this disclosure. In some examples, the annotated query database includes an index that maps a hash of a query (or of a parsed query) to an original query and/or to a corresponding annotated query. For example, an entry or index for a particular query may include a hash of the query, the query itself, and a corresponding annotated query. In some examples, when checking the annotated query database 240 to determine if a query has been previously received (and determine if an annotated query exists in the annotated query database 240), the query mapper 210 may calculate the hash value to use as an index entry to find possible query matches, then compare the received query to any entries having the same hash value. In such examples, the query mapper 210 may then find the same query by parsing and comparing the original query and received query. If the same query is found from the entries with the same hash value, the query mapper may then retrieve the corresponding annotated query from the database to provide to the optimizer 230.

While an example manner of implementing the query manager 110 of FIG. 1 is illustrated in FIG. 2, at least one of the elements, processes and/or devices illustrated in FIG. 2 may be combined, divided, re-arranged, omitted, eliminated and/or implemented in any other way. Further, the query mapper 210, optimizer interface 220, annotated query generator 230, annotated query database 240 and/or, more generally, the example query mapper 110 of FIG. 2 may be implemented by hardware and/or any combination of hardware and executable instructions (e,g., software and/or firmware), Thus, for example, any of the query mapper 210, optimizer interface 220, annotated query generator 230, annotated query database 240 and/or, more generally, the example query mapper 110 could be implemented by at least one of an analog or digital circuit, a logic circuit, a programmable processor, an application specific integrated circuit (ASIC), a programmable logic device (PLD) and/or a field programmable logic device (FPLD). When reading any of the apparatus or system claims of this patent to cover a purely software and/or firmware implementation, at least one of the query mapper 210, optimizer interface 220, annotated query generator 230 and/or annotated query database 240 is/are hereby expressly defined to include a tangible machine readable storage device or storage disk such as a memory, a digital versatile disk (DVD), a compact disk (CD), a Blu-ray disk, etc. storing the executable instructions. Further still, the example query manager 110 of FIG. 2 may include at least one element, process, and/or device in addition to, or instead of, those illustrated in FIG. 2, and/or may include more than one of any or all of the illustrated elements. processes and devices.

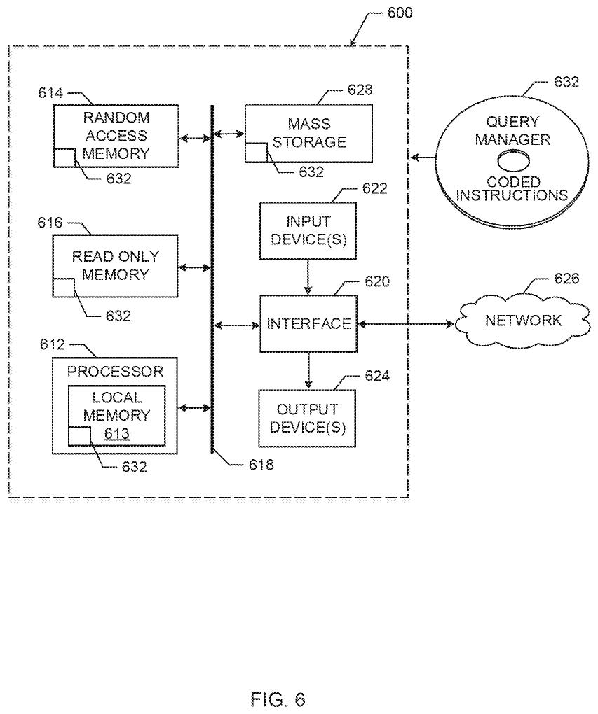

Flowcharts representative of example machine readable instructions for implementing the query manager 110 of FIG. 2 are shown in FIGS. 3, 4, and 5. In this example, the machine readable instructions comprise a program(s)/process(es) for execution by a processor such as the processor 612 shown in the example processor platform 600 discussed below in connection with FIG. 6. The program(s)/process(es) may be embodied in executable instructions (e.g., software) stored on a tangible machine readable storage medium such as a CD-ROM, a floppy disk, a hard drive, a digital versatile disk (DVD), a Blu-ray disk, or a memory associated with the processor 612, but the entire program/process and/or parts thereof could alternatively be executed by a device other than the processor 612 and/or embodied in firmware or dedicated hardware. Further, although the example program(s)/process(es) is/are described with reference to the flowchart illustrated in FIGS. 3, 4, and 5, many other methods of implementing the example query manager 110 may alternatively be used. For example, the order of execution of the blocks may be changed, and/or some of the blocks described may be changed, eliminated, or combined.

The example process 300 of FIG. 3 begins with an initiation of the query manager 110 (e.g., upon startup, upon instructions from a user, upon startup of a device implementing the query manager 110 (e.g., the database management system 100), etc.). The example process 300 of FIG. 3 may be executed to generate an annotated query corresponding to a query to use as an execution plan for a subsequent processing of the query. At block 310, the query mapper 210 provides a parsed query to the optimizer 130. The optimizer 130 may then select an appropriate execution plan for the query. At block 320, the optimizer interface 220 identifies an execution plan selected by the optimizer 130 based on the query,

At block 330 of FIG. 3, the annotated query generator 230 generates an annotated query based on the selected execution plan. The annotated query includes hints in a query to execute the selected execution plan. At block 340, the annotated query generator 230 stores the annotated query in the annotated query database. The stored annotated query of block 340 may subsequently be used upon receipt of the query of block 310 (or a substantially similar query). After block 340, the example process 300 ends.

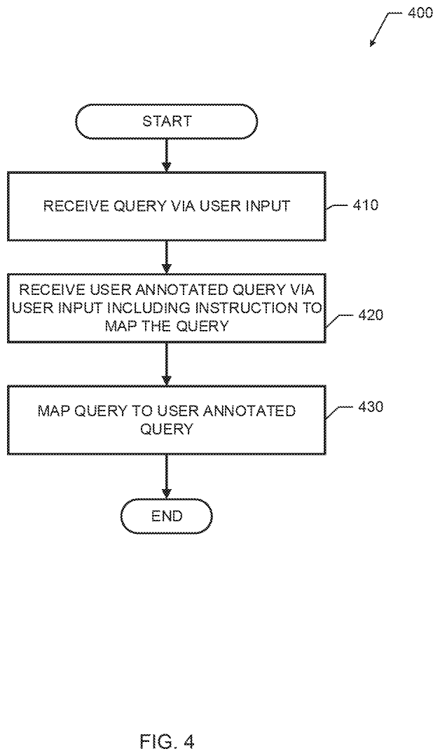

The example process 400 of FIG. 4 begins with an initiation of the query manager 110. The example process 400 of FIG. 4 may be executed to store user annotated queries received from a user. At block 410, the query mapper 210 receives a query via the user input 120. At block 420, the query mapper 210 receives a user annotated query via the user input 120 including instructions to map the query to the user annotated query.

At block 430, the query mapper 210 maps the query to the user annotated query in the annotated query database 240. For example, at block 430, the query mapper 210 may calculate a hash of the query, and store the hash, the query, and the annotated query in an entry of the annotated query database 240 and/or an index of the annotated query database 240. After block 430, the example process 400 ends.

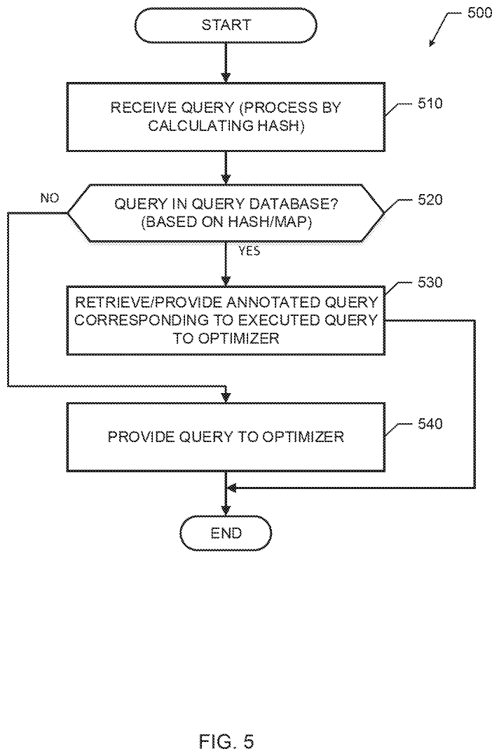

The example process 500 of FIG. 5 begins with an initiation of the query manager 110. The example process 500 may be executed to provide either a query or an annotated query to the optimizer 130. At block 510, the query mapper 210 receives a query. In some examples, the query mapper 510 may parse the query and/or calculate a hash of the query at block 510. At block 520, the query mapper 210 determines whether the query is in the annotated query database 240.

If, at block 520, the query is in the annotated query database 240 (e.g., based on a comparison of a hash of the query and a hash in the annotated query database 240, based on a comparison of the query and a query in the annotated query database 240), the optimizer interface 220 provides an annotated query corresponding to the query from the annotated query database 240 to the optimizer 130 (block 530). If, at block 520, the query mapper 510 determines that the query is not in the annotated query database 240, the optimizer interface 220 provides the query to the optimizer 230. After blocks 530. 540, the example process 500 ends. After the process 500 ends, the example optimizer 130 may select an execution plan for the execution engine to process the query and/or annotated query.

As mentioned above, the example processes of FIGS. 3, 4, and 5 may be implemented using coded instructions (e,g., computer and/or machine readable instructions) stored on a tangible machine readable storage medium such as a hard disk drive, a flash memory, a read-only memory (ROM), a compact disk (CD), a digital versatile disk (DVD), a cache, a random-access memory (RAM) and/or any other storage device or storage disk in which information is stored for any duration (e.g., for extended time periods, permanently, for brief instances, for temporarily buffering, and/or for caching of the information). As used herein, the term tangible machine readable storage medium is expressly defined to include any type of machine readable storage device and/or storage disk and to exclude propagating signals and to exclude transmission media. As used herein, “computer readable storage medium” and “machine readable storage medium” are used interchangeably. Additionally or alternatively, the example processes of FIGS. 3, 4, and 5 may be implemented using coded instructions (e,g., computer and/or machine readable instructions) stored on a non-transitory computer and/or machine readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory machine readable medium is expressly defined to include any type of machine readable storage device and/or storage disk and to exclude propagating signals and to exclude transmission media. As used herein, when the phrase “at least” is used as the transition term in a preamble of a claim, it is open-ended in the same manner as the term “comprising” is open ended. As used herein the term “a” or “an” may mean “at least one,” and therefore, “a” or “an” do not necessarily limit a particular element to a single element when used to describe the element. As used herein, when the term “or” is used in a series, it is not, unless otherwise indicated, considered an “exclusive or,”

FIG. 6 is a block diagram of an example processor platform 600 capable of executing the instructions of FIGS. 3, 4, and 5 to implement the query manager 110 of FIG. 2. The example processor platform 600 may be or may be included in any type of apparatus, such as a server, a personal computer, an Internet appliance, or any other type of computing device.

The processor platform 600 of the illustrated example of FIG. 6 includes a processor 612. The processor 612 of the illustrated example is hardware. For example, the processor 612 can be implemented by at least one integrated circuit, logic circuit, microprocessor or controller from any desired family or manufacturer.

The processor 612 of the illustrated example includes a local memory 613 (e.g., a cache). The processor 612 of the illustrated example is in communication with a main memory including a volatile memory 614 and a non-volatile memory 616 via a bus 618. The volatile memory 614 may be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory 616 may be implemented by flash memory and/or any other desired type of memory device. Access to the main memory 614, 616 is controlled by a memory controller.

The processor platform 600 of the illustrated example also includes an interface circuit 620. The interface circuit 620 may be implemented by any type of interface standard, such as an Ethernet interface, a universal serial bus (USB), and/or a peripheral component interconnect (PCI) express interface.

In the illustrated example, at least one input device 622 is connected to the interface circuit 620. The input device(s) 622 permit(s) a user to enter data and commands into the processor 612. The input device(s) can be implemented by, for example, an audio sensor, a microphone, a camera (still or video), a keyboard, a button, a mouse, a touchscreen, a track-pad, a trackball, isopoint and/or a voice recognition system.

At least one output device 624 is also connected to the interface circuit 620 of the illustrated example. The output device(s) 624 can be implemented, for example, by display devices (e.g., a light emitting diode (LED), an organic light emitting diode (OLED), a liquid crystal display, a cathode ray tube display (CRT), a touchscreen, a tactile output device, a light emitting diode (LED), a printer and/or speakers). The interface circuit 620 of the illustrated example, thus, may include a graphics driver card, a graphics driver chip or a graphics driver processor. The example input device 622 and output device 624 may be used to implement the user interface 120 of FIG. 1.

The interface circuit 620 of the illustrated example also includes a communication device such as a transmitter, a receiver, a transceiver, a modem and/or network interface card to facilitate exchange of data with external machines (e.g., computing devices of any kind) via a network 626 (e,g., an Ethernet connection, a digital subscriber line (DSL), a telephone line, coaxial cable, a cellular telephone system, etc.),

The processor platform 600 of the illustrated example also includes at least one mass storage device 628 for storing executable instructions (e.g., software) and/or data. Examples of such mass storage device(s) 628 include floppy disk drives, hard drive disks, compact disk drives, Blu-ray disk drives, RAID systems, and digital versatile disk (DVD) drives.

The coded instructions 632 of FIGS. 3, 4, and 5 may be stored in the mass storage device 628, in the local memory 613 in the volatile memory 614, in the non-volatile memory 616, and/or on a removable tangible machine readable storage medium such as a CD or DVD,

From the foregoing, it will be appreciated that the above disclosed methods, apparatus and articles of manufacture provide a query manager to generate annotated queries from execution plans selected by an optimizer of a database management system. In some examples, a user may map a query to user annotated queries created by the user to cause the execution engine to process the query in a set manner. Accordingly, the examples herein provide for storage of execution plans for queries that may be used to stabilize timing of retrieving data for a query.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

What is claimed is:

1. A method comprising:
providing a first query to an optimizer;
identifying a first execution plan selected by the optimizer based on the first query;
generating an annotated query based on the selected first execution plan, the annotated query comprising hints for executing the selected first execution plan; and
storing the annotated query in a database, the annotated query to cause the optimizer to generate a second execution plan corresponding to the first execution plan based on the hints.

2. The method as defined in claim 1, further comprising:
calculating a hash of the first query;
mapping the hash to the annotated query in an index of the database.

3. The method as defined in claim 1, further comprising:
receiving a second query via a user input;
receiving a second annotated query via the user input, the second annotated query comprising user hints;
mapping the second query to the second annotated query, the second annotated query to be provided to the optimizer to select a third execution plan based on the user hints.

4. The method as defined in claim 1, further comprising:
receiving a second query that matches the first query:
providing the annotated query to the optimizer in response to receiving the second query.

5. The method as defined in claim 4, further comprising:
determining the second query matches the first query by:
calculating a hash value of the second query;
determining that the hash value of the second query matches a hash value of the first query; and
retrieving the annotated query from the database.

6. The method as defined in claim 5, further comprising:
parsing the first query and the second query; and
verifying that the second query matches the first query by confirming the parsed first query matches the parsed second query.

7. The method as defined in claim 5, further comprising:
retrieving the annotated query in the database from an index of the database, the index mapping the hash value of the first query to the annotated query.

8. A non-transitory machine readable storage medium comprising instructions that, when executed, cause a machine to at least:
calculate a hash of a received query;
determine that an annotated query associated with the received query is stored in a database based on the hash; and
provide the annotated query to an optimizer, the optimizer to select an execution p for the received query based on hints stored in the annotated query.

9. The machine readable storage medium of claim 8, comprising instructions that, when executed, further cause the machine to:
compare the hash to an index hash;
determine the hash matches the index hash;
compare the received query to a database query associated with the index hash;
determine that the received query matches the database query;
determine that the annotated query is associated with the database query; and
determine that the annotated query is associated with the received query.

10. The machine readable storage medium of claim 8, comprising instructions that, when executed, further cause the machine to:
provide the annotated query based on an execution plan previously selected by the optimizer, the execution plan executed for a previously received query that matches the received query.

11. The machine readable storage medium of claim 10, comprising instructions that, when executed, further cause the machine to:
store a mapping of the previously received query to the annotated query in the database.

12. An apparatus comprising:
a query mapper to generate a hash of a received query;
an annotated query generator to generate an annotated query based on an execution plan selected for the query by an optimizer, the annotated query comprising hints for executing the execution plan; and
an optimizer interface to:
provide the query to the optimizer when the hash of the received query does not match a hash in an index of a database; and
provide the annotated query to the optimizer when the hash of the received query matches a hash in an index of a database that maps the query to the annotated query,

13. The apparatus of claim 12, wherein the annotated query comprises hints corresponding to the execution plan.

14. The apparatus of claim 13, wherein the hints define an order of operations that are to be performed in executing the annotated query.

15. The apparatus of claim 13, wherein the hints comprise at least one of a join order, a join type, a projection type, a projection to skip, a data distribution, or a flexible execution hint.
